(19) United States
(12) Patent Application Publication
(10) Pub. No.: US 2013/0270171 A1
(43) Pub. Date: Oct. 17, 2013

(54) FILTRATION SYSTEM AND ASSEMBLY THEREOF

(71) Applicants: Ra'anan Ben-Horin, D.N. Jordan Valley (IL); Avi Levi, Kahal (IL); Ud Mussel, D.N. Lower Galilee (IL)

(72) Inventors: Ra'anan Ben-Horin, D.N. Jordan Valley (IL); Avi Levi, Kahal (IL); Ud Mussel, D.N. Lower Galilee (IL)

(73) Assignee: AMIAD WATER SYSTEMS LTD., D.N. Upper Galil 1 (IL)

(21) Appl. No.: 13/993,558

(22) PCT Filed: Dec. 13, 2011
(86) PCT No.: PCT/IL11/50057

§ 371 Date: Jun. 12, 2013

Related U.S. Application Data
(60) Provisional application No. 61/422,814, filed on Dec. 14, 2010.

(51) Int. Cl. B01D 29/54; F16L 15/04; B01D 46/00

(52) U.S. Cl. CPC B01D 29/54; B01D 46/0021; F16L 15/04
USPC 210/345; 210/435; 210/323.1; 55/422; 285/355; 285/351

(57) ABSTRACT

A filtration system comprising a tank-like housing, accommodating a filtration assembly secured within the housing and extending between a respective raw fluid inlet port and a filtered fluid outlet port. The filtration assembly comprises one or more filter units secured over a main pipe disposed within the housing and configured between a fixed, operative position, and a manipulating position. The housing is configured with at least one re-sealable opening on a side wall thereof, through which the filter units are serviced at the manipulating position.

### FIELD OF THE DISCLOSED SUBJECT MATTER

The present disclosed subject matter relates to filtration systems and their assembly. More particularly the disclosed subject matter is concerned with such filtration systems offering high accessibility for servicing thereof.

The present disclosed subject matter further relates to articulation of filter units to such filer systems.

The disclosed subject matter is further concerned, according to another aspect thereof, with and articulation mechanisms for screw coupling a tubular element to different bodies.

### BACKGROUND OF THE DISCLOSED SUBJECT MATTER

Any filtration systems ,however in particular those treating significant large volumes of liquid and those treating liquids of particular high level of contamination (e.g. sewage, industrial waste, etc.), must undergo periodical servicing.

For example, ballast water taken into a ballast tank from one body of water and discharged in another body of water can introduce invasive species of aquatic life. The taking in of water from ballast tanks has been responsible for the introduction of species that cause environmental and economic damage. Thus many countries have already implemented ballast water management procedures for vessels entering or trading within their waters. Among others, theses procedures require filtration of the ballast water as it pumped into the ballast tank.

Thus, there is a need to provide filtration systems configured for readily available and easy servicing, also at confined space and systems having restricted access thereto.

Servicing of a flirtation system requires attending the one or more filter units received therein. Thus, for easy and yet sealed-type coupling between a filter unit there is need for suitable connection arrangement between the one or more filter units and the filter housing.

One such arrangement is disclosed in U.S. Patent Application No. 2007/0029249 claiming a liquid filtering device, particularly for irrigation water installations comprising a housing with an inlet port and an outlet port; a core member centrally mounted within the housing comprising at one axial end thereof an abutment ring associated with a male screw-thread for mounting the core member to the housing next to and in communication with the inlet port; a discs-type filter member supported by the core-member so that water flowing from the inlet port enters the filter member in a radial direction, and is discharged through the outlet port, and vice-versa during reversed, filter flushing flow cycles; a piston assembly mounted to the core member comprising a piston and a displaceable member coupled to the piston and abutting against the filter member at the other axial side thereof; characterized in that the mounting of the core member comprises a female screw-threaded split ring matching the male screw-thread; and a circular convergent cone shaped trough encompassing the split ring and fixedly mounted to housing, the arrangement being such that upon threading together, the split-ring is attracted towards the abutment ring and thus becomes self-tightened against the cone-shaped wall of the trough.

### SUMMARY OF THE DISCLOSED SUBJECT MATTER

According to a first aspect of the present disclosed subject matter there is disclosed a filtration system comprising a tank-like housing, accommodating a filtration assembly secured within the housing and extending between a respective raw fluid inlet port and a filtered fluid outlet port; said filtration assembly comprising one or more filter units secured over a main pipe disposed within the housing and configured between a fixed, operative position, and a manipulating position; said housing configured with at least one re-sealable opening on a side wall thereof, through which the filter units are serviced at the manipulating position.

The term service/serviced as used herein the specification and claims in connection with the filter units includes introducing and mounting the filter units on the main pipe, removal of the filter units and their maintenance e.g. cleaning, replacing of parts, etc.

Fluid flow path through the filtration system can extend from the raw fluid inlet port, into a confined space within the main pipe, filtered through the one or more filter units and out through the filtered fluid outlet port. According to a different, reverse, configuration fluid flow path through the filtration system extends from the raw fluid inlet port, into a space within the housing, filtered through the one or more filter units into a confined space within main pipe, and out through the filtered fluid outlet port.

The main pipe is manipulable through an opening at a top portion of the housing, at least about a longitudinal axis thereof, and optionally is rotatable about said longitudinal axis to facilitate access to all the filter units mounted on the main pipe through the at least one sealable opening on the side wall thereof.

The main pipe defines an internal confined space being in fluid communication with an external space within the housing only through said filter units, wherein a bottom portion of said main pipe is sealingly yet detachably secured to a receiving portion of the housing. The term bottom denotes an end of the main pipe remote from the opening of the housing through which the main pipe is manipulable.

The main pipe is configured for detachably securing thereto a plurality of filter units. According to a particular design said filter units radially extend from the main pipe.

The main pipe is configured for axial and rotary displacement about its longitudinal axis through an opening at a top portion of the housing and is fitted for sealing articulation thereto at the operative position.

The main pipe is further configured at a top portion thereof for detachably attaching to a manipulating system for hoisting and rotating same about its longitudinal axis.

The at least one sealable opening on the side wall of the housing is configured for reopening and closing, however in a sealed fashion, to facilitate servicing the filter units. A closing member is thus configured for re-closing the opening in a sealed and pressure tight fashion.

According to a particular example, the filtration system is used as a ballast filtration system in a marine vessel.

It is appreciated that the filter unit in the following examples can be any type of filtering media such as a stack of filtering disks, a filtering screen (i.e. a fine mash of material), a thread-type filter, pile-type filter, and the like. In addition, combinations of different types of filter units can be applied in a unitary housing.

The filter units are detachably attached to the main pipe in a sealed fashion by screw-type couplings or by bayonet-type couplings (the latter being a particular case of screw-type couplings).

Also, Fluid is defined as any flowable matter, i.e. gas or liquid, regardless its purpose, degree of contamination, particle size, viscosity, pressure or any other parameters. Hence, herein in the specification and claims the term fluid is used in its broadest sense.

The longitudinal axis of the housing can extend vertically, horizontally or otherwise inclined.

Raw fluid denotes a fluid (gas or liquid) to be filtered, and Rinsing fluid denotes a fluid (gas or liquid) used for rinsing/flushing the filter unit or filtering media or other components of the filter assembly. It is noted that in some cases filtered fluid serves as a rinsing fluid. Filtered fluid denotes the fluid/liquid obtained after a filtration process, namely after removing particles and contaminating matter.

Respective inlet ports and outlet ports may serve for more than one function. For example, a certain port may function at one stage as a raw fluid inlet port and at another stage may function as a waste/rinsing outlet port.

The disclosed subject matter, by a further aspect thereof, is concerned with a manipulating device and method for displacing the main pipe within the housing to facilitate service thereto.

According to one example, the manipulating device comprises a frame configured for bearing over an external surface of the tank-like housing, an engaging unit for coupling to a top portion of the main pipe, and a manipulating mechanism for at least hoisting and/or rotating the main pipe with respect to the housing.

The frame can be a tripod-like leg configuration, comprising three or more support legs.

According to another aspect of the present disclosed subject matter there is provided an articulation mechanism for screw coupling a tubular element to different bodies.

According to a particular example, the articulation mechanism is used for detachably attaching a filter unit to a main pipe of a filter assembly.

According to a particular example there is provided an articulation mechanism for screw coupling a tubular element to a body, said tubular element comprising a cylindrical body configured at a coupling end thereof with an externally threaded segment and an outwardly extending shoulder above said threaded segment, a seal support ring received within the coupling end; said body configured with an axial projecting ring with an opening having an internal threading corresponding with said external threading; and a seat portion projecting inwards from the threading; whereby screw fastening the tubular element with the body entails screw coupling therebetween with sealing engagement of the sealing support ring against the seat portion and bearing of the shoulder against said body shoulder.

According to a particular configuration, the seal support ring accommodates a sealing ring.

According to a modification of the articulation mechanism, a conical tightening ring is provided over at least a conical surface of the positioning segment of the body, said conical tightening ring bearing against at least a portion of the shoulder of the tubular element, whereby screw fastening the tubular element with the body entails urging of the conical tightening ring against the conical surface of the positioning segment, thereby causing the conical tightening ring to expend into a fastened sealed engagement therebetween

According to an embodiment of the disclosed subject matter, the articulation mechanism is configured with a locking arrangement to thereby prevent spontaneous (unintended) unlocking (opening) of the tubular element from the body.

By particular example, the positioning segment of the body is configured with one or more locking slots and a locking ring is configured with at least one locking pin (projections), the arrangement being such that screw fastening the tubular element with the body entails locking engagement of the locking pins within said locking slots.

It is however appreciated that the locking slots can be configured on the locking ring and respectively the locking pins are configured on the positioning segment of the body.

The one or more locking slots and the at least one locking pin are radially disposed.

According to yet an example, positioning segment of the body comprises one or more locking pins radially projecting therethrough and configured for axial displacement between an extracted, open position, and a depressed, locked position, arresting the cylindrical body of the tubular element and preventing it from rotating.

According to yet a locking configuration, the positioning segment of the body is configured with an inwardly tapering wall portion and an internally threaded conical ring rests over the seat portion of the body; whereby screw fastening the tubular element with the body results in axial progression of the tubular element towards the body such that axial displacement results in generating a radially inwards directed compression force component that acts to tighten the coupling between the tubular element and the body.

Yet a different locking configuration comprises a cylindrical anchor ring configured with an external conical surface and one or more spring locking members which in an uncompressed state are bent radially inward; a support ring with matching conical shape to that of outer conical wall is mounted over the external conical surface, wherein screw fastening the tubular element with the body into a fully secured state results in bending the arced spring teeth into a straightened position wherein compression of the spring teeth radially outward exerts an inward force on the lower cylinder, thus securing cylindrical insert and rigidly connected tubular element a secured state.

### BRIEF DESCRIPTION OF THE DRAWINGS

In order to understand the disclosed subject matter and to see how it may be carried out in practice, examples will now be described, by way of non-limiting examples only, with reference to the accompanying drawings, in which:

FIG. 1 is an isometric view of a filtration system array according to an example of the present disclosed subject matter;

FIGS. 2A to 2F are consecutive steps of mounting a plurality of filter units on a main pipe of the filtration system;

FIG. 3 is a close-up visualizing the main pipe, a filter unit mounted thereon through an opening of the housing;

FIG. 4 is a schematic motion represents of the main pipe within the housing;

FIG. 5 is a schematic fluid flow scheme, of one example, of the filtration system according to the present disclosed subject matter;

FIGS. 6A to 6G; are examples of sealingly securing configurations of the main pipe to a bottom portion of the housing;

FIGS. 7A to 7D are different examples of sealingly mounting configurations of the main pipe to a receiving portion at a top portion of the housing;

FIG. 8A is a longitudinal sectional view of a connection between a filter unit and a filter base in a partially engaged state;

FIG. 8B is a longitudinal sectional view of the connection between the filter unit and the filter base in a fully secured state;

FIG. 9A is a longitudinal sectional view of another example of a connection between the filter unit and a filter base in a partially engaged state with a mechanical tightening mechanism;

FIG. 9B is a longitudinal sectional view of the mechanism of FIG. 9A in a fully secured state;

FIG. 10A a longitudinal sectional view of another example of the connection between the filter unit and a filter base in a partially engaged state with a mechanical tightening mechanism;

FIG. 10B is a longitudinal sectional view of the mechanism of FIG. 10A in a fully secured state;

FIG. 10C is a plan view of a filter base from the mechanism shown in FIG. 10A;

FIG. 10D is a bottom view of a lock-pin ring from the mechanism shown in FIG. 10A;

FIG. 11A is a longitudinal sectional view of the another example of a connection between the filter unit and a filter base in a partially engaged state with mechanical tightening mechanism;

FIG. 11B is a sectional view of the mechanism of FIG. 10A in a fully secured state;

FIG. 12A is a longitudinal sectional view of another connection between the filter unit and a filter base in a partially engaged state;

FIG. 12B is a longitudinal sectional view of the mechanism of FIG. 12A in a fully secured state;

FIG. 13A is a side elevation of a main pipe manipulating device mounted over a housing of a filtration system; and

FIG. 13B is a top view of FIG. 13A.

### DETAILED DESCRIPTION OF EMBODIMENTS

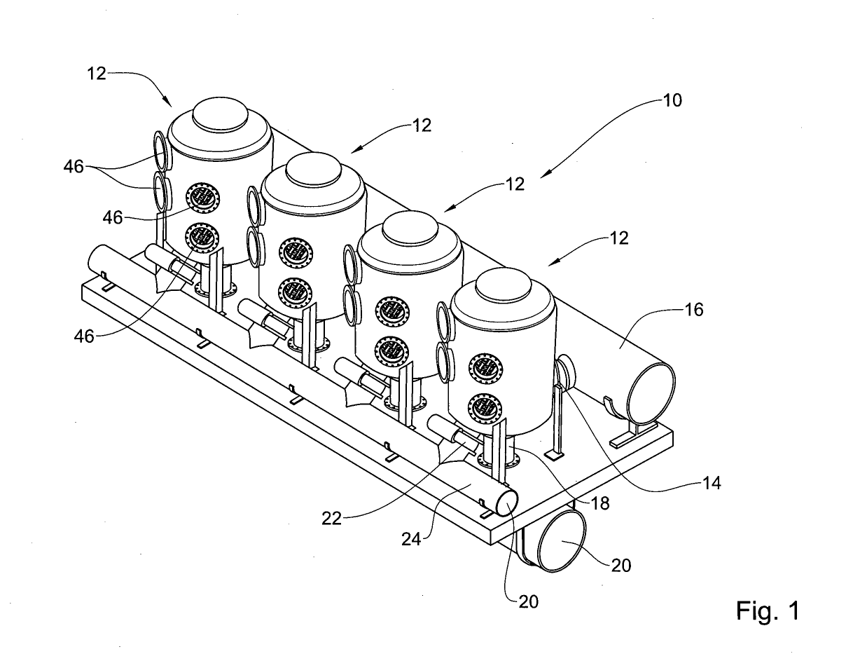

Attention is first directed to FIG. 1 of the drawings illustrating a filtration system array generally designated 10 e.g. a ballast water filtration system of the type used in marine vessels (not shown), configured for filtration of large amounts of water within the relatively short time. It is appreciated that such filtration system arrays are often installed in space-tight configurations, at times as a retro-fit mounting, within the marine vessels and thus, access to the filtration system is often limited due to tight space rendering it hard for installation and periodic servicing. The filtration system array 10 comprises, in the present example, four filtration systems 12, wherein the filtration systems are each configured with a raw fluid inlet port 14 coupled in turn to a raw fluid supply line 16 and a filtered fluid outlet port 18 coupled to a filtered fluid line 20. Likewise, the filter systems are configured with a rinsing fluid port 22 being in flow communication with a rinsing fluid supply line and draining line 24.

It is however appreciated that the configuration of the inlet ports and outlet ports may differ as far as location and their function namely, respective inlet ports and outlets ports may serve for more than one function. For example, a certain port may function at one stage as a raw fluid inlet port and at another stage may function as a waste/rinsing outlet port.

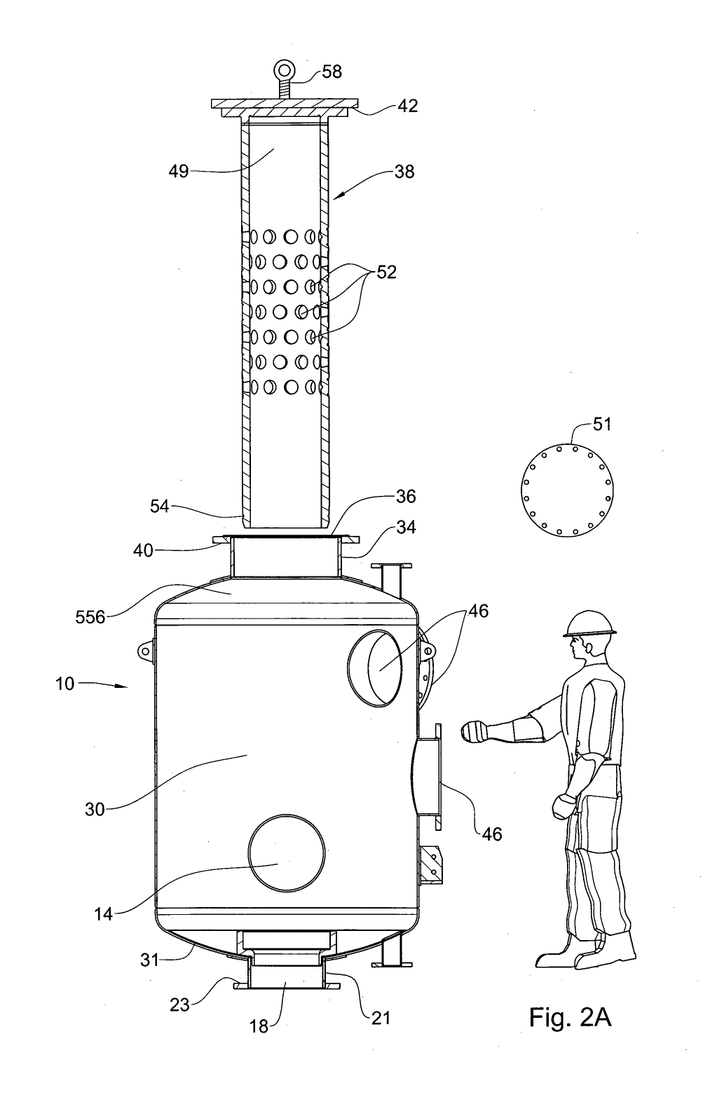

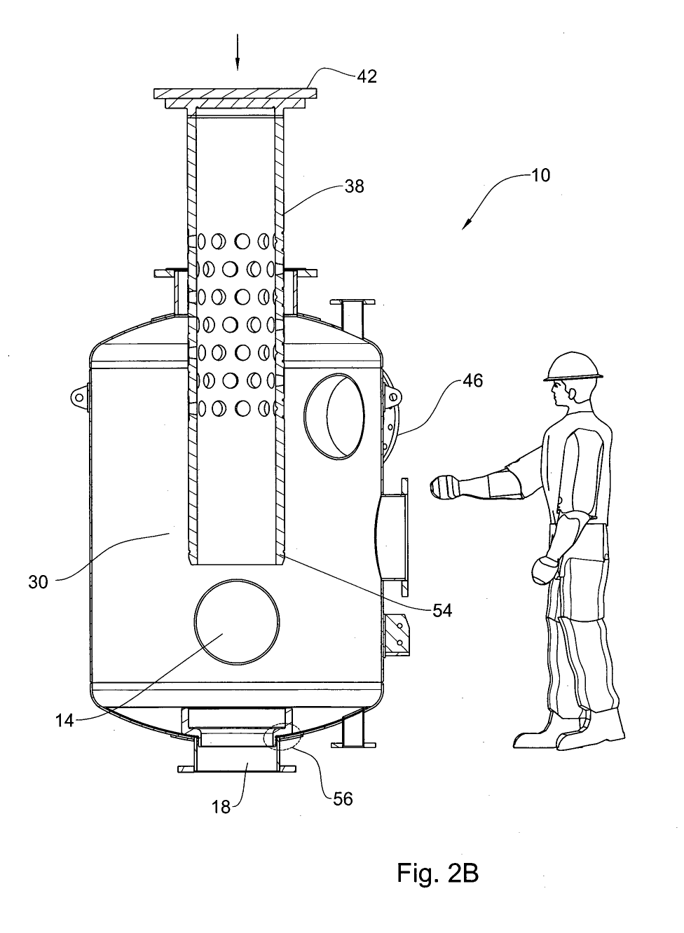

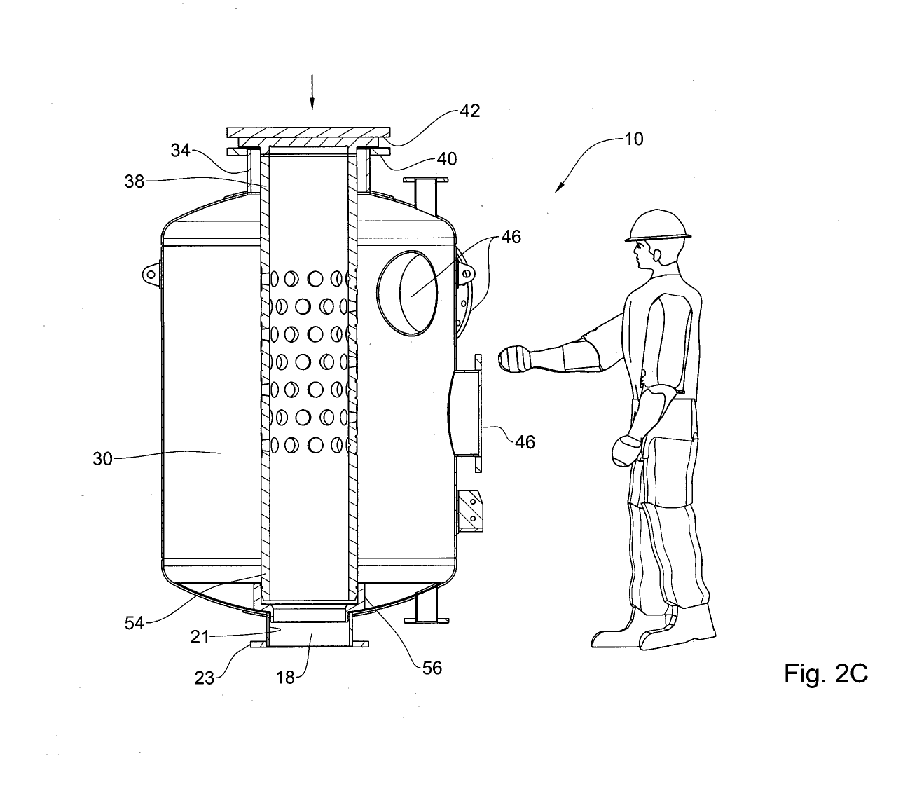

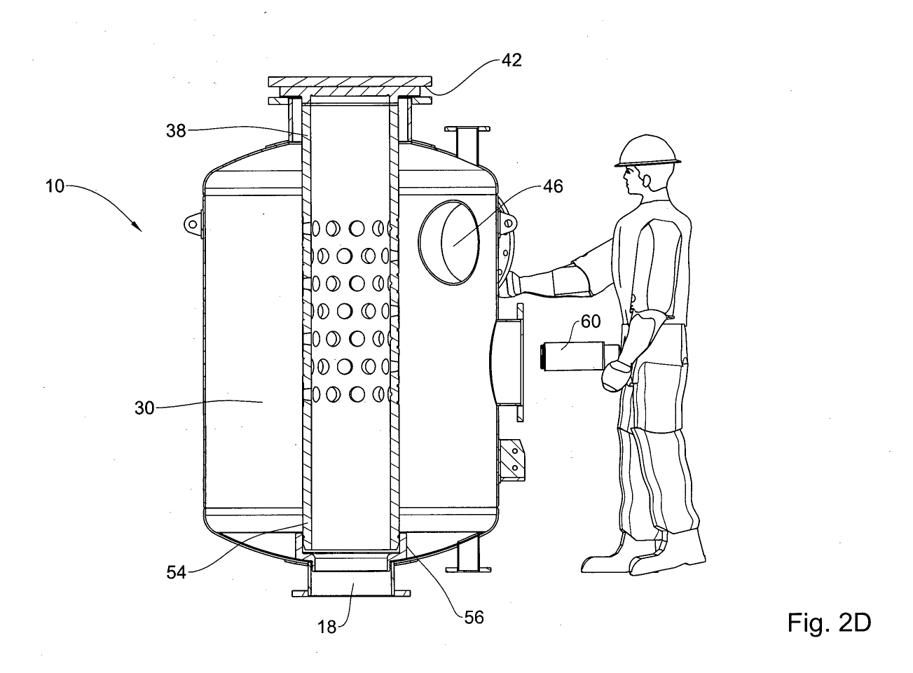

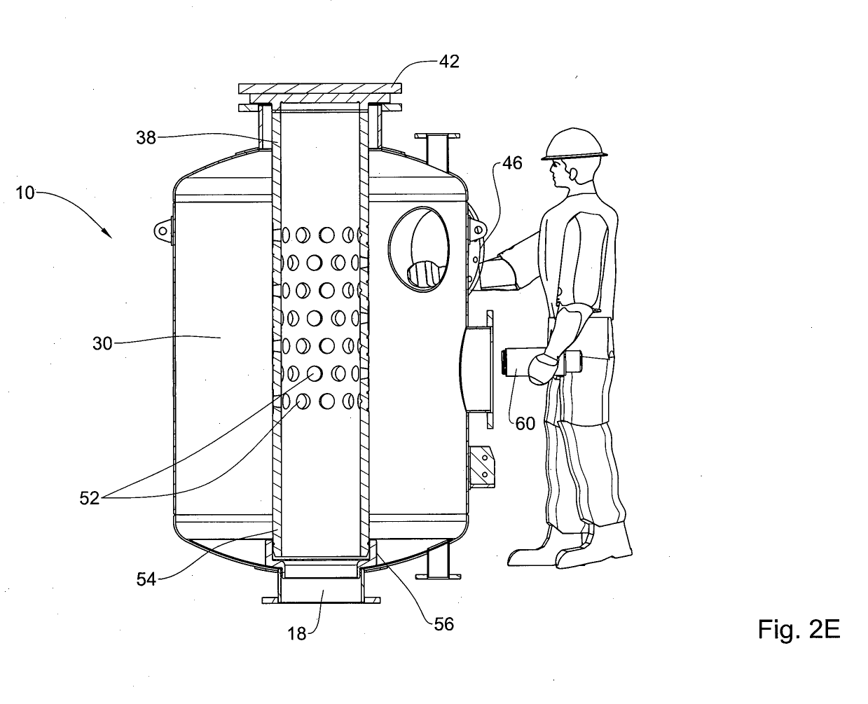

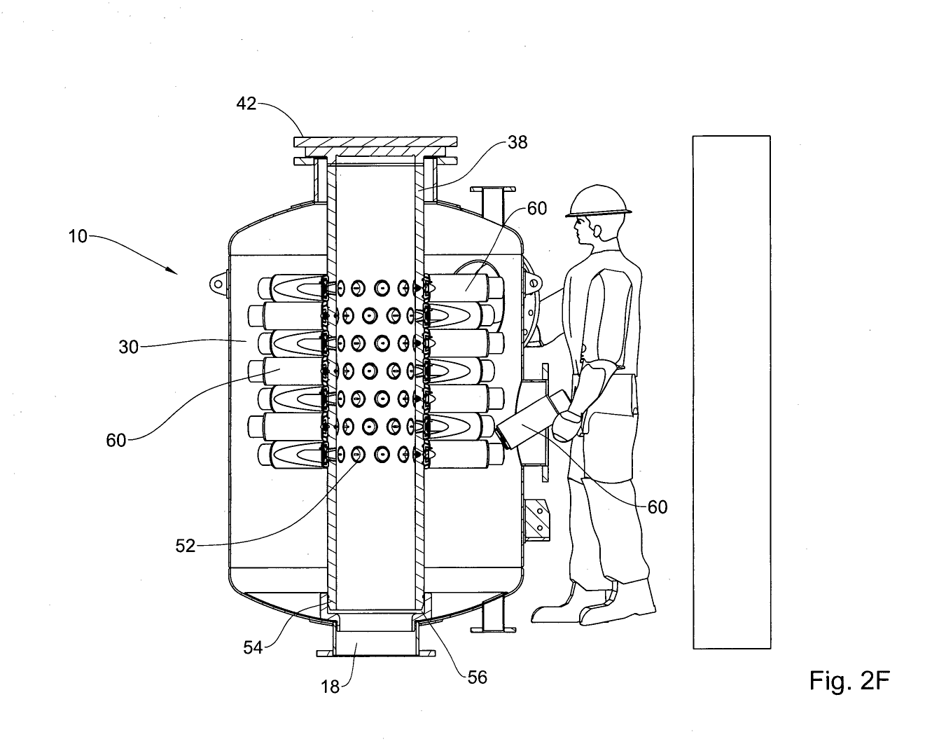

Further attention is now directed also to FIGS. 2A through 2F illustrating a filtration system 10 in accordance with the present disclosed subject matter, comprising a cylindrical, tank-like housing 30 configured with a raw fluid inlet port 14 configured at a side wall of the housing 30, and a filtered fluid outlet port 18, configured coaxially at a bottom portion of the housing 30. The filtered fluid outlet port 18 extends through a tubular segment 21 at a lowermost portion of the housing 30 and is configured with a flanged portion 23 facilitating for coupling to a filtered fluid collecting pipe and for securing the filtration system.

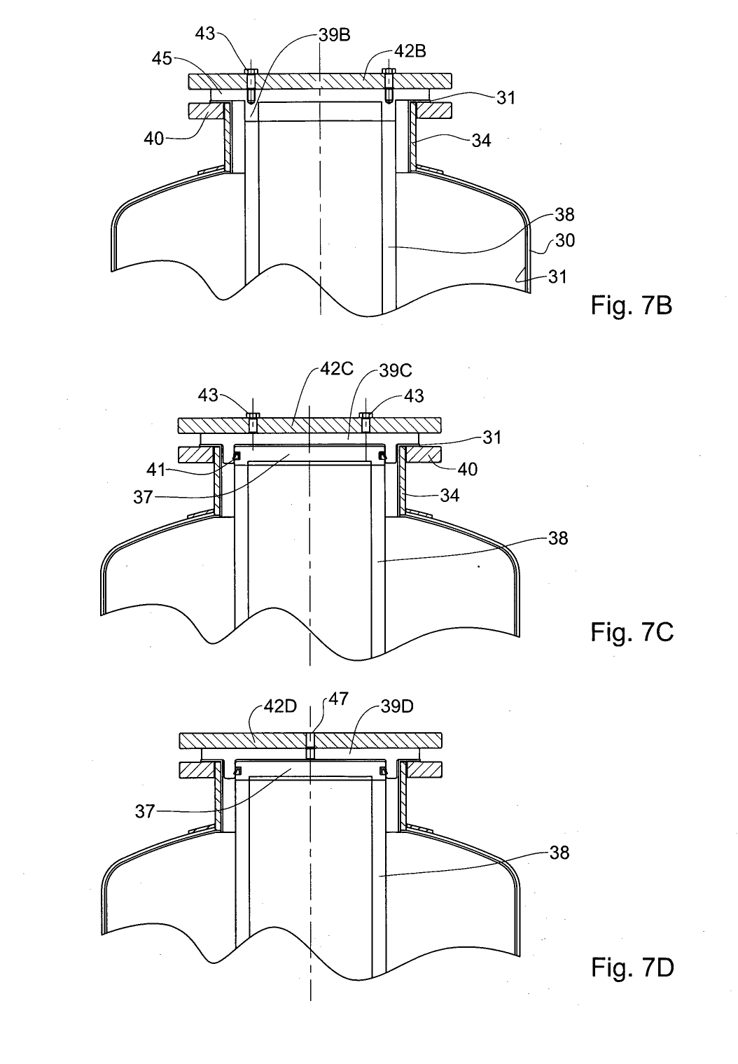

At a top portion of the housing 30 there is configured a cylindrical neck-portion 34 with a top opening 36 adapted for receiving a main pipe 38 as will be discussed hereinafter. The neck-portion 34 is fitted at its top with a locking arrangement, namely a flange 40 configured for sealing locking arresting a corresponding flanged portion 42 of the main pipe 38 as will be discussed hereinafter in connection with FIGS. 7A through 7D.

The housing 30 is further configured with several sealable openings 46 (seen clearly also in FIG. 1) said openings 46 comprising cover members 51 (one only shown in FIG. 2A and removed from other locations for sake of illustration) however, configured for reopening and closing in a sealed session, to thereby facilitate easy servicing of the filtration system as will be discussed hereinafter. The closing member of the apertures 46 may be for example flanged cover members articulated by bolts or other tightening mechanisms.

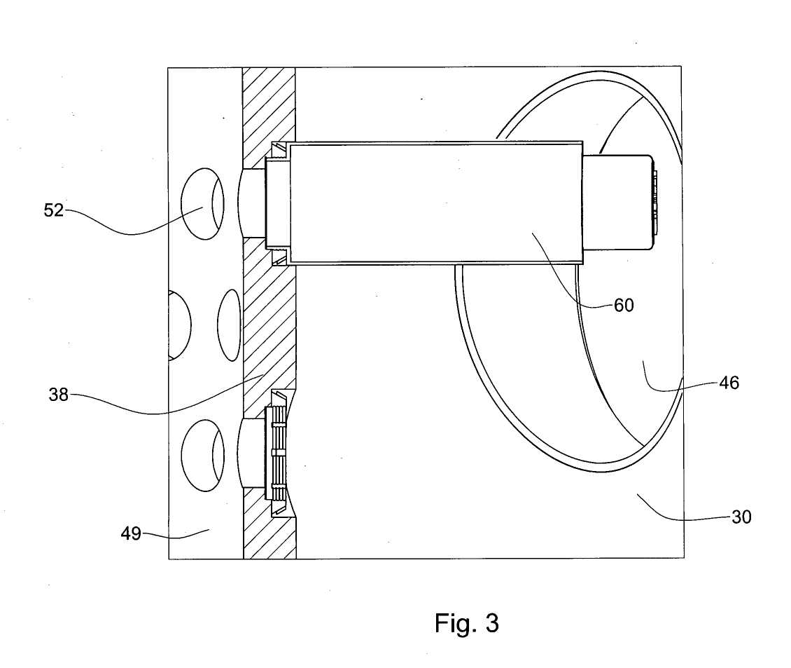

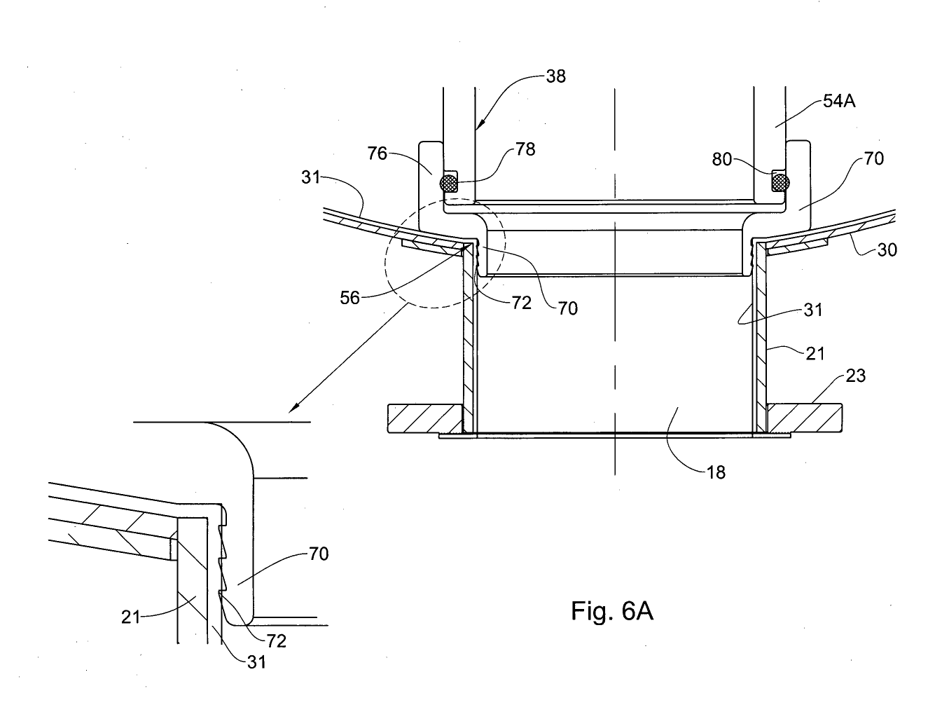

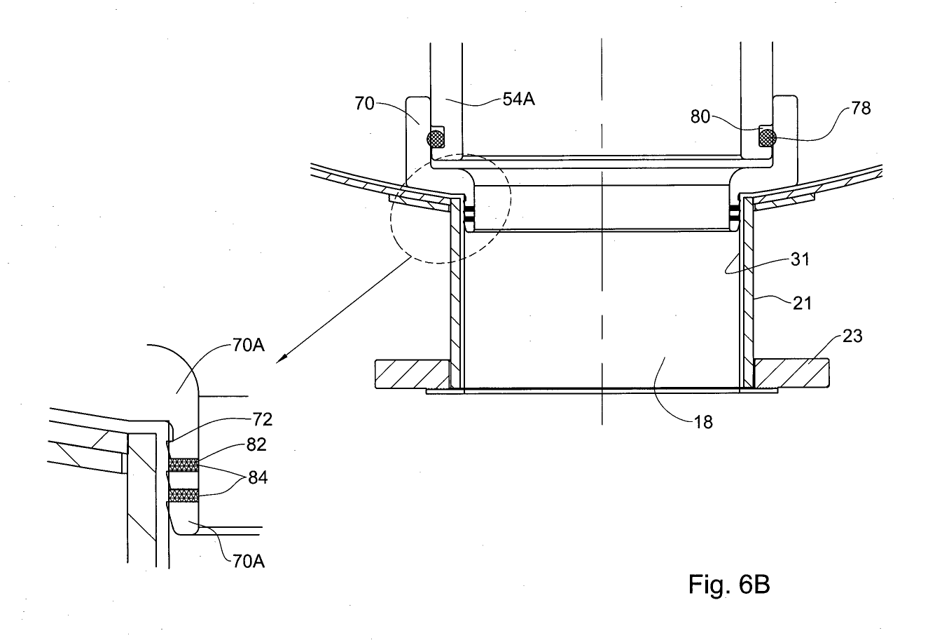

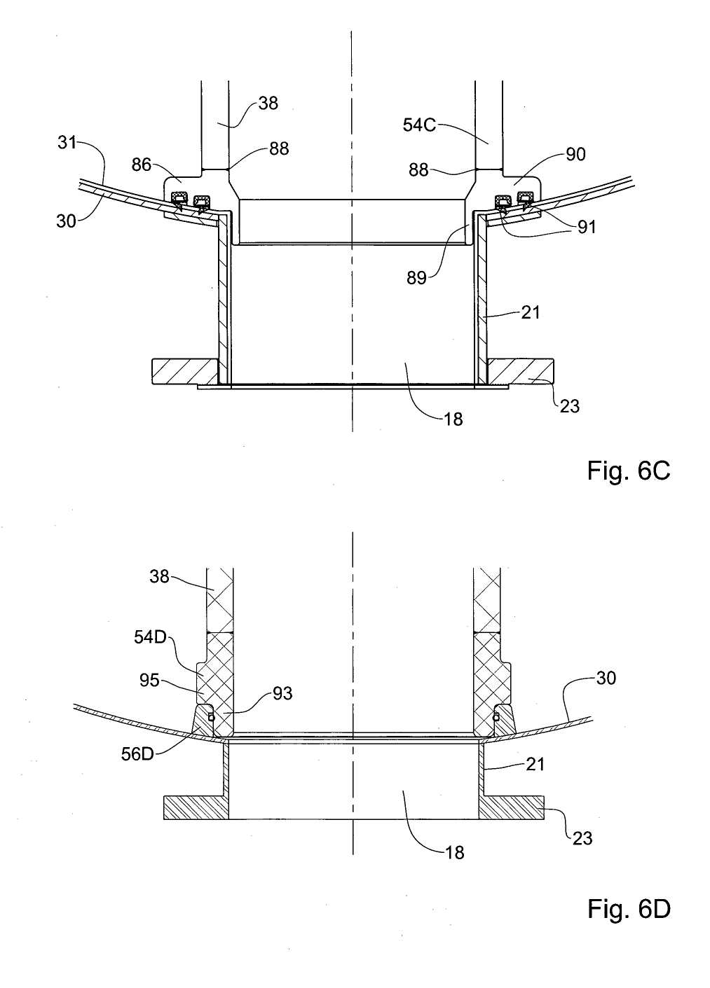

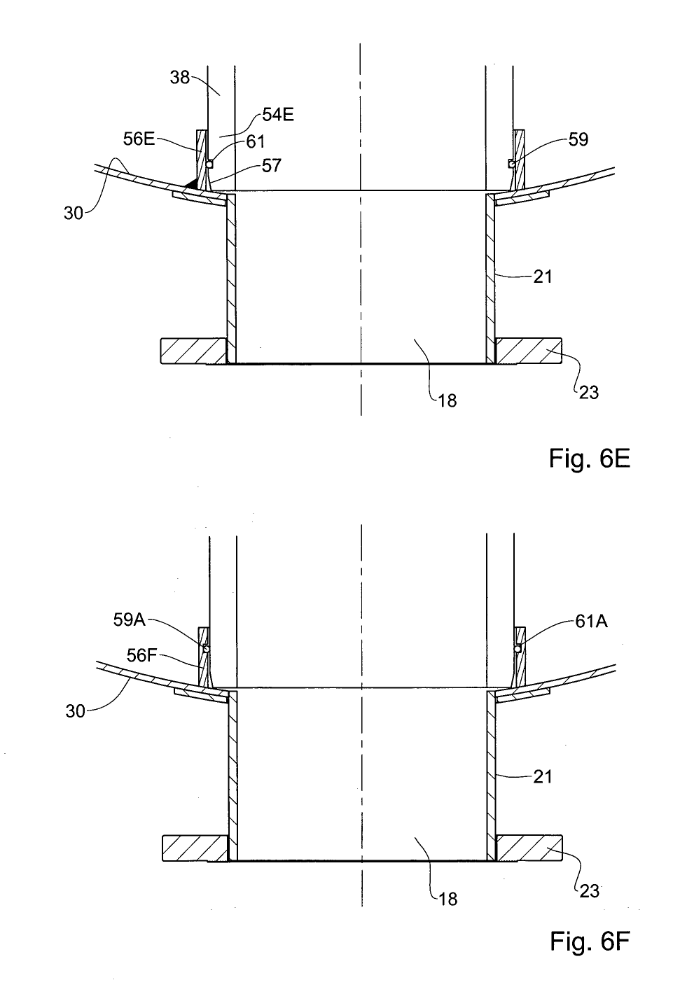

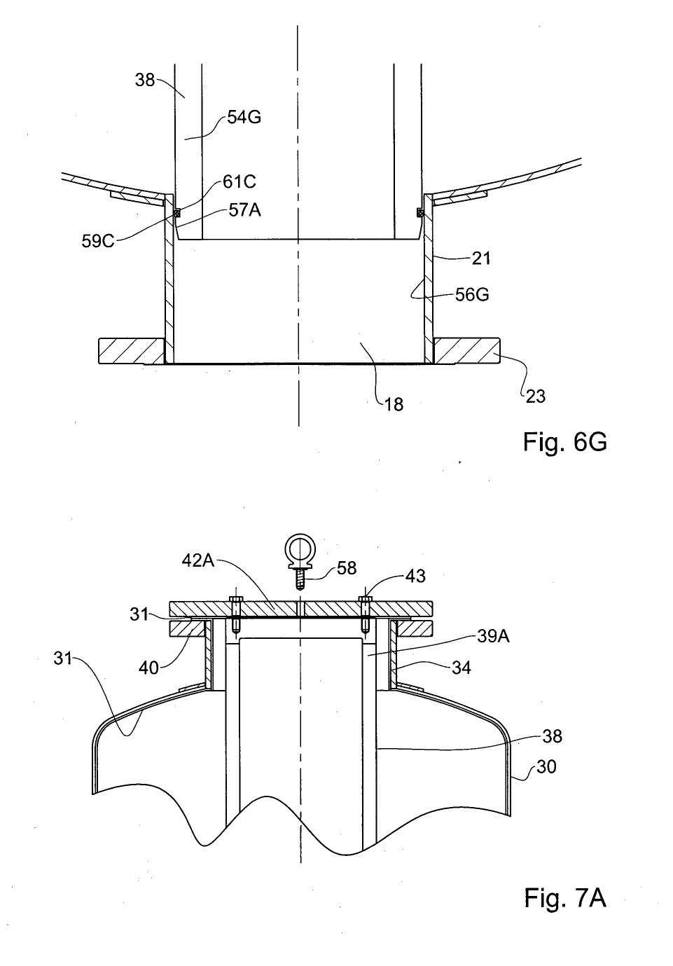

The main pipe 38 is a hollow pipe defining an internal space 49 and is configured with a plurality of filter unit couplers 52 as will be discussed hereinafter with further detail with respect to FIGS. 3 and 6. A bottom portion 54 of the main pipe is configured for sealing engagement with a corresponding receiving portion 56 at a bottom portion of the housing 30, however in a sealing and detachably secured fashion, as will be discussed hereinafter with further reference to FIGS. 6A-6G. Assembling the filtration system 10 takes place by hoisting the main pipe 38, e.g. by a hoisting hook 58 (shown for example in FIG. 2A; the hook 58 may be fixed or detachable attached to the cover) whereby the main pipe 38 is placed above the opening 36 of the housing 30 and is then slowly lowered into the housing (FIG. 2B) until the main pipe 38 reaches the receiving portion 56 of the housing 30 arresting it in a sealed manner to be discussed hereinafter.

Introducing the main pipe 38 into the housing 30 is done with care, so as to avoid damage to an inside liner layer 31 of the housing, said liner provided for coating the inside surface of the housing to prevent corrosion thereof. The liner can be made of rubber material, suitable layer of material such as paint or other polyurethanes, and the like. The liner can be adhered, or molded, or painted or otherwise applied and treated, as may be required.

Once the main pipe 38 is fully received within the housing 30, with the bottom portion 54 received within the receiving portion 56 of the housing, the flanged portion 42 of the main pipe 38 rests over the corresponding flanged portion 40 of the neck portion 34 of the housing, whereby the main pipe 38 is locked in place as will be discussed hereinafter.

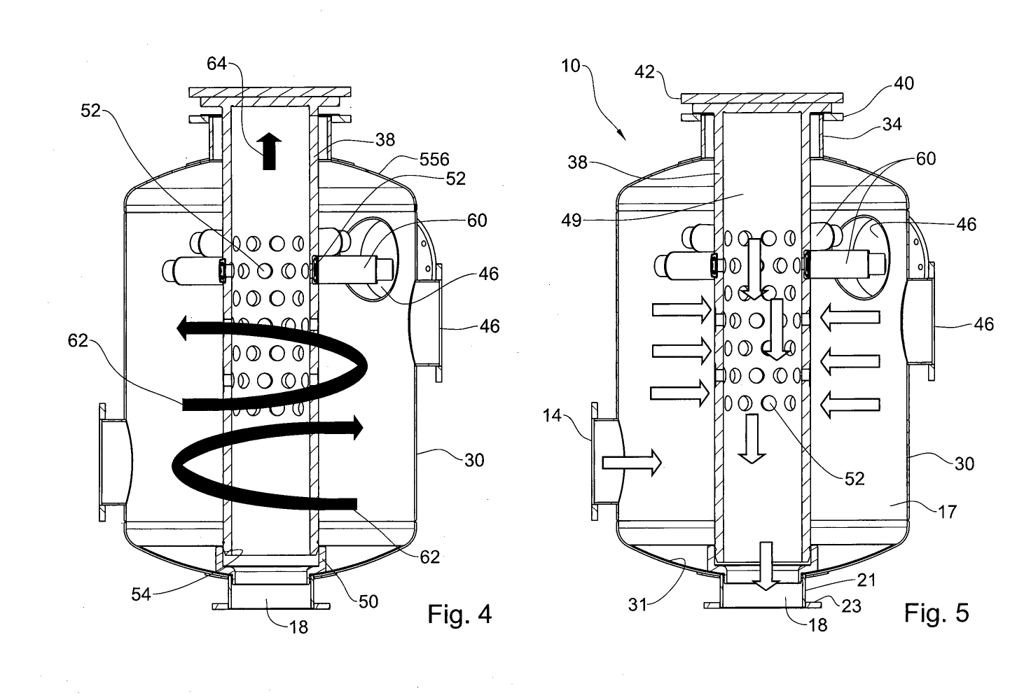

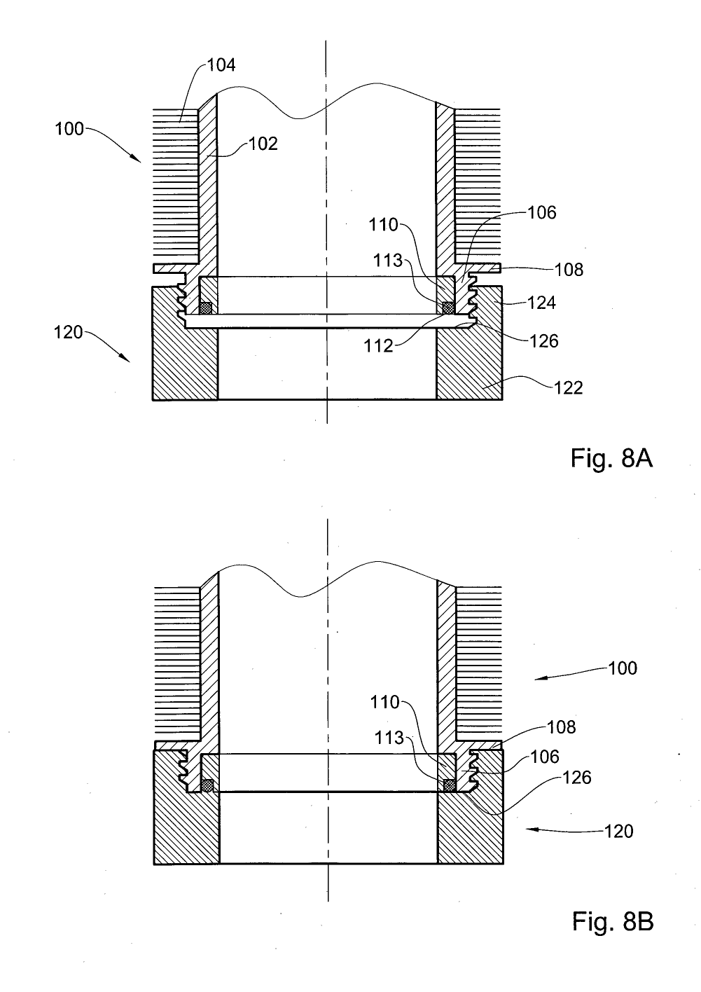

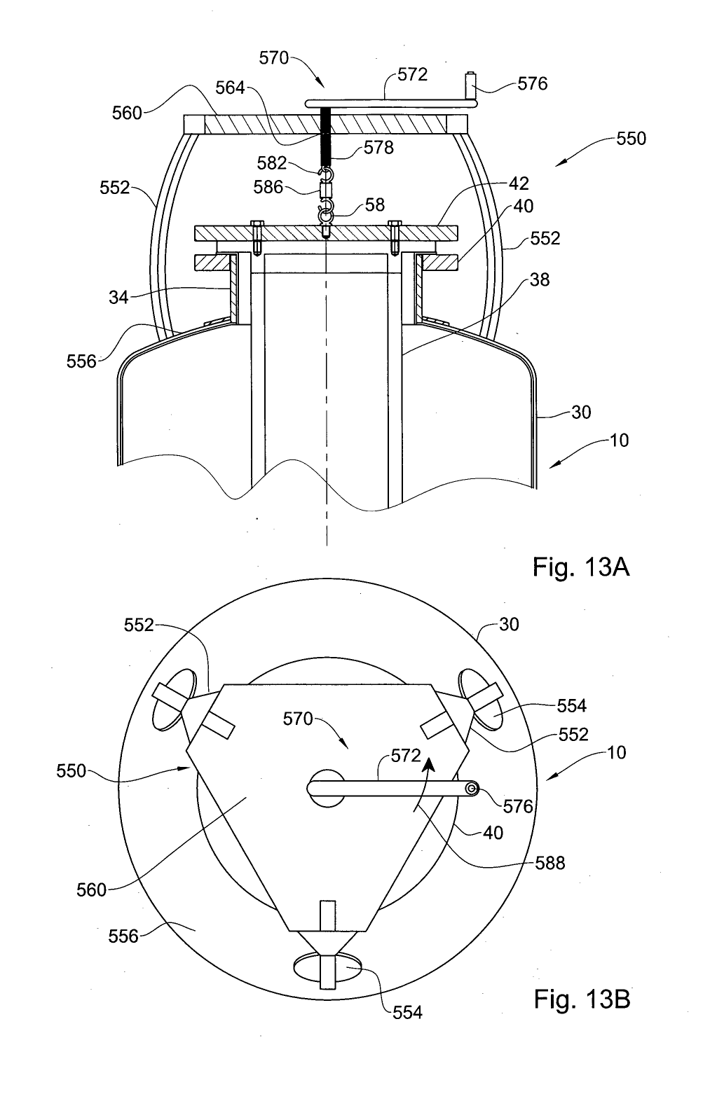

However, assembling the filtration system 10 further requires the installation of a plurality of filter units 60 onto the coupling 52 performed on the main pipe 38. Mounting the filter unit 60 onto the main pipe 38 takes place by slightly elevating and slowly rotating the main pipe 38, as schematically represented by arrows 62 and 64 in FIG. 4, such that at each incremental axial or angular displacement a coupler 52 extends opposite a respective opening 46 of the housing allowing serving a respective filter unit 60, namely its secured attachment to the main pipe 38 as will be discussed hereinafter in detail with reference to FIGS. 8 to 12. It is appreciated that at each incremental position of the main pipe 38 one or more filter units 60 may be serviced at the time or, and depending on the position, size and number of openings 46, several filter units 60 may be serviced at the time (FIG. 2F), though this may require several individuals. Elevation and rotation of the main pipe may be facilitated for example by the manipulating device disclosed hereinafter in connection with FIGS. 13A and 13B.

The arrangement is such that the main pipe 38 need be elevated by several centimeters only, in order to detach its bottom portion 54 from the receiving portion 56 of the housing 30, thereby facilitating rotation of the main pipe about its longitudinal axis so as to maintain and service the system with or without the filter units 60 mounted thereto (e.g. attach/detach the filter units 60, etc.). Rotation of the main pipe 38 may be a complete 360° manipulation, once or more, about the longitudinal axis, or several reciprocal angular displacements, depending on the geometry and distribution of the filter units 60 about the main pipe and the service openings 46.

FIG. 5 illustrates a filtration process wherein raw fluid enters through raw fluid inlet port 14 into the space 17 within the housing 30, whereby fluid is forced through the filtering units 60 and is thus filtered as it flows into the confined space 49 within the main pipe 38, whereby filtered fluid flows out through the filtered fluid outlet port 18. However, as already mentioned hereinbefore, according to different configurations (not shown) respective inlet ports and outlet ports may serve for more than one function, e.g. the configuration may be reversed such that the raw fluid inlet port 14 serves as a filtered fluid outlet port, vice versa and likewise, further openings may be provided serving as waste/rinsing outlet ports (not shown).

Turning now to FIGS. 6A through 6G, different examples are exemplified, illustrating how the bottom portion 54 of the main pipe 38 is sealingly, yet detachably secured to the receiving portion 56 of housing 30.

In FIG. 6A, there is illustrated a first example of sealingly securing a bottom portion 54A of the main pipe 38 to the receiving portion 56A of the housing 30. In this example, a seat member 70 is securely received at the bottom portion of the housing 30 with an axial portion thereof 72 configured with a plurality of annular laterally projecting locking teeth 72 (see enlarged portion) sealingly engaged within the resilient coating layer 31 within the tubular portion 21 of the housing 30. In order to obtain sealing engagement the coating layer 31 should be configured with a minimal thickness and elasticity, to allow for the locking teeth 72 to sealingly engaged within the resilient coating layer.

The seat member 70 further configured with an upwardly extending annular portion 76 configured for sealingly supporting the bottom portion 54A of the main pipe 38, wherein a sealing O-ring 78 is received within a respective groove 80 formed at the bottom portion 54A. The arrangement being such that the main pipe 38 is axially displaced into the annular portion 76 such that it is sealingly received and supported thereby. It is appreciated that the inner top edge of the annular portion 76 may be chamfered or comprised a suitable radii to facilitate smooth insertion of the bottom end 54A of the main pipe 38.

The arrangement illustrated in FIG. 6B is similar to that depicted in FIG. 6A, however, with the addition of an adhesive agent 82 applied through apertures 84 formed at the downward projection 70A of the seat member, thus securing the seat member 70 within the tubular portion 21 of housing 30. The adhesive agent can be a two or more-component material which hardens after mixing of the components, etc.

In FIGS. 6C the bottom portion 54C of the main pipe 38 is configured with an adaptor portion 86 integrated with the main pipe 38, typically by welding at 88. Said adaptor portion 86 is configured with a downward extension 89 projecting into the annular portion 21 of the housing 30 and a lateral projecting portion 90 configured with a pair of hydraulic seals 91 bearing over the resilient liner 31 in a seal-type fashion. The downward projection 89 bears within the annular portion 21 preventing displacement of the main pipe 38 within the housing 30.

In the configuration illustrated in FIG. 6D, the main pipe 38 is integrated at its bottom end with a bottom portion 54D having a downward projection 93 and an annular lateral projection 95, with a receiving portion 56D in the form of an annular projection upwardly extending from the bottom surface of the housing 30, with a sealing gasket (O-ring) received at an inner surface of the upward projection 56D, whereby the bottom portion 54D is configured for sealing arresting by the receiving portion 56D. Bottom portion 54D is welded at the bottom of the main pipe 38.

The upward projecting receiving portion 56D is typically welded at the bottom portion of the housing 30. The annular projection 95 is configured for resting over a top surface of the receiving portion 56D so as to limit its downward displacement within the housing.

With further reference now being made to FIG. 6E, there is illustrated a configuration wherein the bottom portion 54E of the main pipe 38 is substantially straight and continuous, though its bottom-most outer edge 57 is chamfered or configured with a radii to facilitate its smooth insertion into the annular upwardly extending receiving portion 56E extending from a bottom surface of the housing 30, and secured thereto by welding. It is noted that the bottom portion 54E of the main pipe is 38 is configured with a sealing gasket (O-ring 59) received within an annular groove 61, to facilitate sealing engagement within the receiving member 56E.

The configuration illustrated in FIG. 6F is similar to that illustrated in FIG. 6E however with the difference being that the sealing gasket, namely O-ring 59A is received within a respective groove 61A configured at the upwardly extending receiving portion 56F welded at the bottom surface of housing 30.

FIG. 6G illustrates an arrangement wherein the main pipe 38 is continuous and comprises a bottom-most outer edge 57A being chamfered, to facilitate its easy insertion into the annular neck portion 21 of the housing, and further there is provided a sealing gasket 59C received within an annular groove 61C formed at the bottom portion 54G of the main pipe 38 and configured for sealingly bearing against an inside surface 56G, constituting the receiving portion.

Turning now to FIGS. 7A through 7D there are illustrated different configurations illustrating how the top end of the main pipe 38 is securely attached over the top end of the housing 30, however without affecting the inner liner coating 31 within the housing 30.

In FIG. 7A, the top end 39A of the main pipe 38 is securely attached to a flanged cover 42A, e.g. by means of bolts 43 (or, in accordance with a different configuration, not illustrated, may be integrally manufactured therewith) whereby the flanged plate 42A is configured for securely coupling to the flanged portion 40 extending above the neck portion 34 of the housing 30, with the lining 31 extending in between the two flanged portions 40 and 42A for sealing purposes.

In FIG. 7B the top end 39B of the main pipe 38 is configured with a lateral shoulder 45 onto which a cover plate 42B is secured by means of bolts 43, whereby the cover plate 42B is flanged for securely coupling to the flanged portion 40 extending from the neck portion 34, whereby the shoulder portion 45 sealingly bears against the liner portion 31 extending laterally over the flanged portion 40.

In FIG. 7C the main pipe 38 is sealed by a cover 37 fitted with a sealing gasket 41 received within an appropriate annular groove, and further there is provided a centralizing plate member 39C sealingly receiving the top cover 37 of the main pipe 38, and with a top plate 42C configured for secure coupling engagement with the flanged portion 40 of the top neck 34 with the top cover 39C sealingly bearing against the liner layer 31 laterally extending of the flanged portion 40.

The example of FIG. 7D is similar to that illustrated in FIG. 7C, with the exception that the top plate 42D is integrated with the top cover 39D whereby there is need to provide a venting port 47 such that when the assembly is mounted over the top plate 37 of the main pipe 38, air is allowed to escape prior to securing thereof. It is noted that the venting port 47 is optional and may be applied to other examples too, e.g. that disclosed in FIG. 7C, however not illustrated.

A plurality of mechanisms may be employed for securing of a filter unit 100 to the main pipe 38.

FIG. 8A shows a sectional view of a generally cylindrical filter unit 100 in a partially engaged state with a generally cylindrical filter base 120 both of which are axially aligned along a single longitudinal axis. The filter unit 100 comprises a filter spine 102 with filter elements 104 encasing the filter spine 102. The filter unit 100 further comprises near a coupling end thereof a shoulder segment 108 at its lower end formed by a ring protruding outward from filter spine 102, and extending below the shoulder segment 108 an externally threaded segment 106 with slightly larger inner radius than the radius of the filter spine 122 to allow for an inserted seal support ring 110 with inner radius equal to that of the filter spine 102. A circumferential groove 112 is formed at the bottom outer edge of seal support ring 110 for positioning of a seal 113. The filter base 120 is ring shaped and comprises a body segment 122 and an internally threaded positioning segment 124 of the body. The body segment 122 has a smaller internal radius than the threaded segment 124 and a seat 126 is formed by the extension of part of the body portion 122 toward the central axis beyond internally threaded segment 124. The filter unit 100 may be connected to the filter base 120 by screwing externally threaded wall segment 106 into internally threaded segment 124.

FIG. 8B shows the mechanism of FIG. 8A in a fully secured state. In this state, the filter unit 100 is screwed into filter base 120 until shoulder segment 108 contacts the upper face (body shoulder) of internally threaded segment 124 and the bottom faces of externally threaded segment 106 and the seal support ring 110 contact the filter base seat 126 thus restricting any further tightening while seal 113 provides a mechanical seal at the connection. The thread connection may be further secured by means of an adhesive or other form of bonding agent.

It is appreciated that the support ring can be made of a relative soft material for improving sealing contact at the coupled position, or with a smooth surface for improved surface-to-surface contact, whereby the provision of a seal may be redundant.

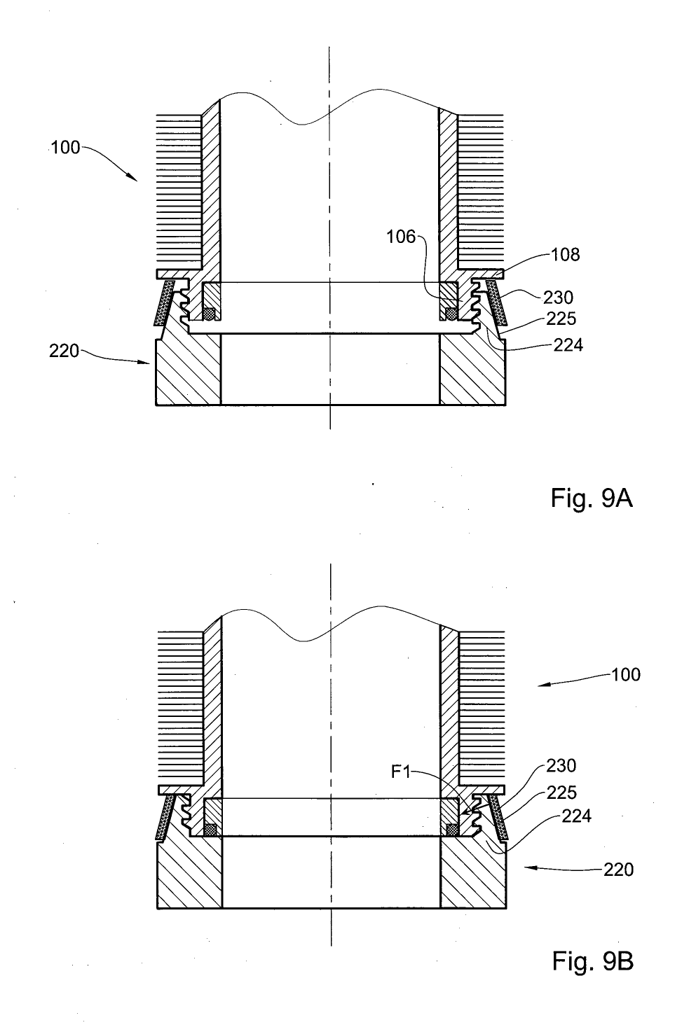

Other mechanisms with means for mechanical tightening may also be utilized in connecting the filter unit 100. In one example, FIG. 9A shows a sectional view of the filter unit 100 in a partially engaged state with filter base 220. In this example, internally threaded segment 224 comprises a conical shape outer wall 225. A conical tightening ring 230 rests on the outer wall 225. Externally threaded segment 106 of filter unit 100 is screwed into internally threaded segment 224 of the filter base 220 until it reaches the fully secured position as seen in FIG. 9B. During the axial motion of the filter unit 100, shoulder segment 108 urges conical tightening ring 230 and forces it to slide against conical shaped outer wall 225 causing the conical tightening ring 230 to slightly expand and exert a compression force component F₁ radially inward on internally threaded segment 224 so as to tighten the thread connection between the filter unit 100 and filter base 220.

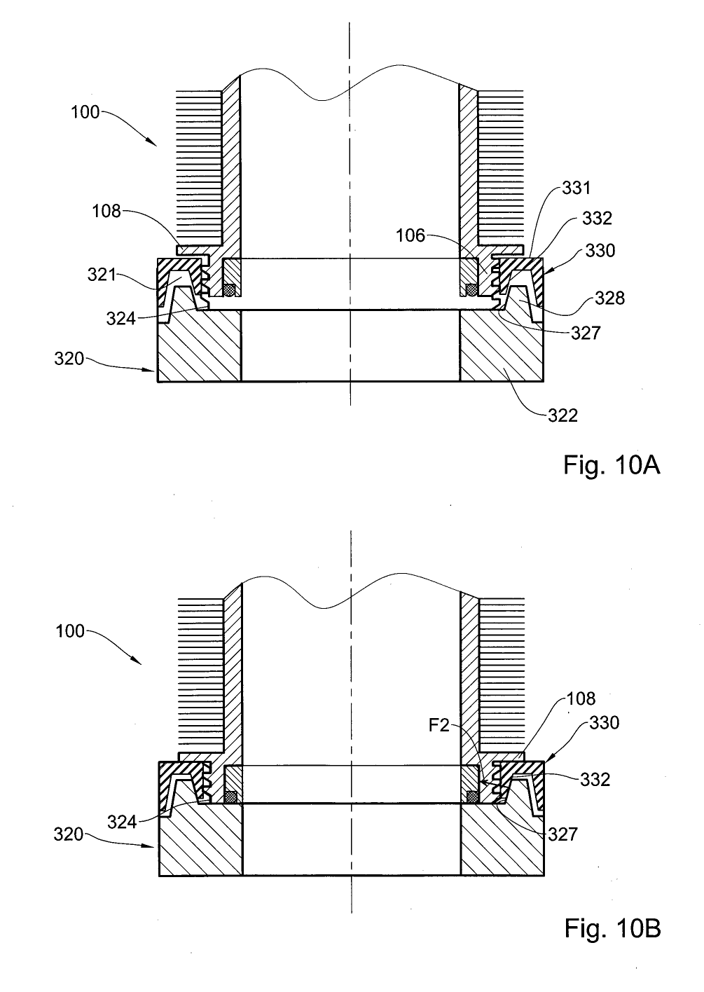

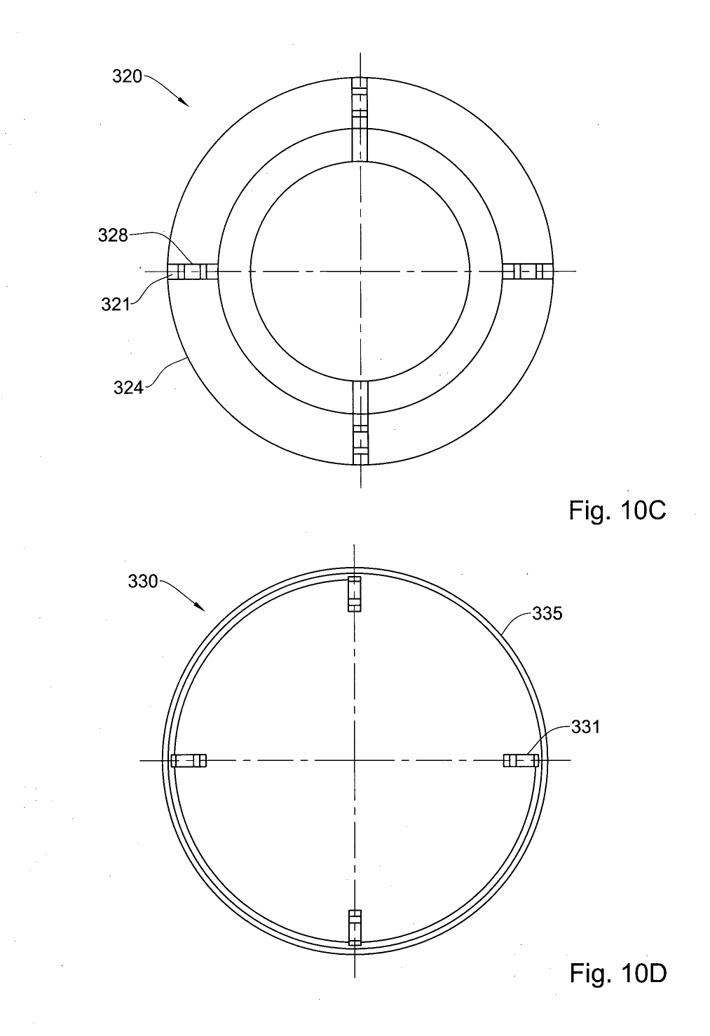

In another mechanism shown in FIG. 10A for securing filter unit 100 to a filter base 320, the filter base 320 comprises a body portion 322, and an internally threaded segment 324, which is similar to threaded segment 124 of FIG. 8A, however in the mechanism of FIG. 10A lock-pin slots 321 are cut into the threaded segment 324 as best seen in FIG. 10C. The filter base 320 further comprises an upper lock-pin positioning segment 328 with angled base wall 327. A locking ring 330 (seen from bottom view in FIG. 10D) comprises a ring segment 335, and lock-pins 331 which are connected to the ring segment 335 and extend radially inward. The lock-pins 331 have angled inner wall 332 (FIG. 10B), and are positioned such that when locking ring 330 rests on filter base 320, the lock-pins 331 fit into the lock-pin slots 321 and the lower portion of angled wall 332 sits on the upper portion of angled base wall 327. FIG. 10A shows the initial engagement of filter element 100 with filter base 320 via their respective threads. Filter unit 100 is then screwed to a secured state shown in FIG. 10B. As it is screwed, shoulder segment 108 pushes the lock-pins 331 axially along the same direction as the filter unit 100 forcing angled wall 332 to slide along angled base wall 327 and exert a force component F₂ on threaded wall 106 at the positions of the lock-pins 331. In this example, four lock-pins 331 are shown. It should be appreciated that the example is not limited to the number shown, and may be any number as determined appropriate.

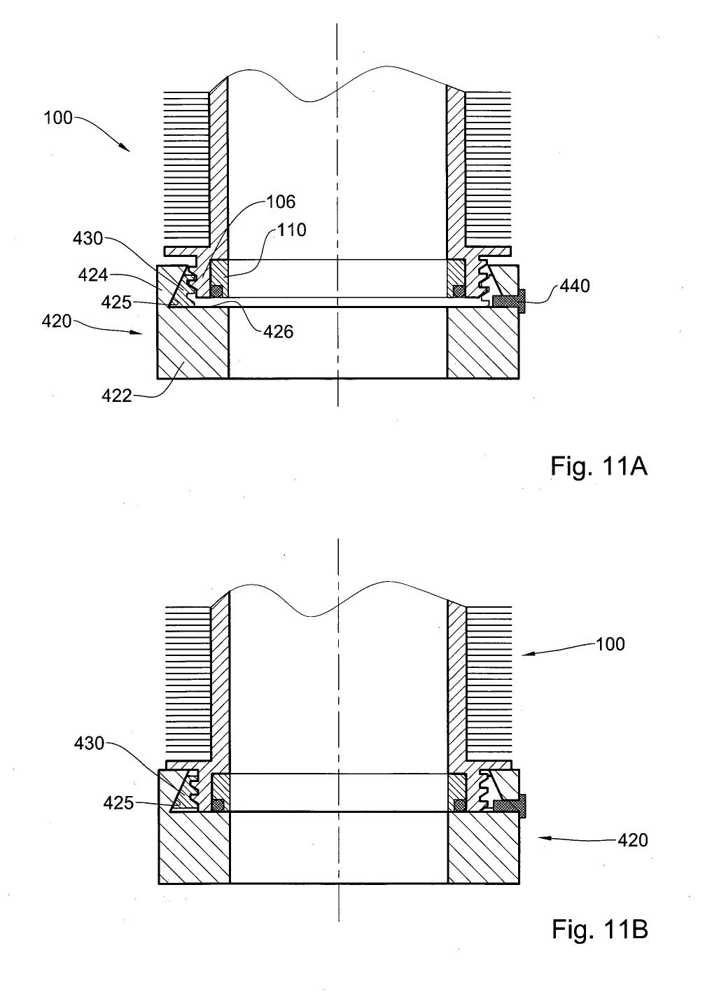

In yet another mechanical tightening mechanism shown in FIG. 11A, a longitudinal section of a partially engaged state of the filter until 100 with a filter base 420 comprising a body segment 422 and an upper segment 424 with conical wall 425. An internally threaded conical ring 430 rests on filter base seat 426. Filter unit 100 moves axially in direction D₁ while it is screwed into internally threaded conical ring 430, which remains resting on filter base seat 426 during this initial engagement. A pin 440 prevents revolving of the internally threaded conical ring 430 during the screwing process. Axial motion of the filter unit in direction D₁ continues during screwing until the bottom faces of externally threaded wall 106 and the seal support ring 110 contact the filter base seat 426 thus preventing additional movement of the filter unit 100 along direction D₁. FIG. 11B shows a fully secured state in which continued screwing of filter unit 100 causes conical ring 430 to move in direction D₂, and to be compressed as it slides along conical wall 425. This compression force component F₄ directed radially inward tightens the threaded connection between the filter unit 100 and filter base 420.

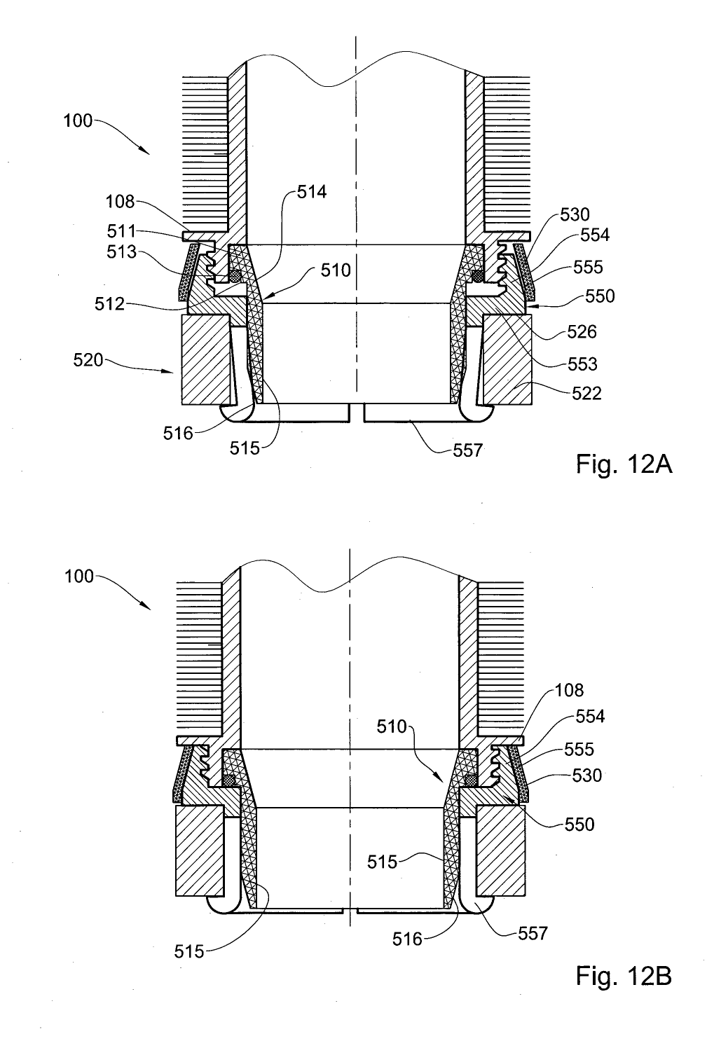

FIG. 12A shows another sectional view of a mechanism for connected the filter unit 100 to a filter base 520 in a partially engaged state. Filter base 520 comprises a body segment 522 and filter base seat 526. In this mechanism, a cylindrical anchor 550 is used as an intermediary securing element between the filter unit 100 and filter base 520. The cylindrical anchor 550 comprises a ring body 552 with shoulder 553, an upper internally threaded wall segment 554 with an outer conical wall 555, and arced spring teeth 557 which in an uncompressed state are bent radially inward. The cylindrical anchor 550 is positioned within filter base 520 such that shoulder 553 sits on filter base seat 526 and arced spring teeth 557 reside within the inner wall of body segment 522.

In this example four arced spring teeth 557 are shown (two in section), however the number is not limited to the example shown. An outer support ring 530 with matching conical shape to that of outer conical wall 555 is optionally mounted around wall segment 554 for additional mechanical tightening of the threaded segments as described above in FIG. 9A and FIG. 9B. Rigidly connected to the filter unit 100 is a cylindrical insert 510, comprising an upper ring 511 with upper groove 512 for positioning of a seal 513 within said groove 512, and a lower cylinder 515. The upper ring 511 may have a conical shaped inner wall 514 to provide an optimum flow transition for fluid flowing through the inner cylinder of the filter unit 100. Additionally the outer edge of the lower cylinder 515 has a tapered wall 516.

In the partially engaged section of FIG. 12A filter unit 100 is screwed into threaded wall segment 554, and lower cylinder 515 coincidently is inserted into cylindrical anchor 550 and tapered wall 516 engages the arced spring teeth 557. As the filter unit 100 is screwed into a fully secured state seen in FIG. 12B, arced spring teeth 557 are bent into a straightened position by lower cylinder 515. The compression of the spring teeth 557 radially outward exerts an inward force on the lower cylinder 515 securing cylindrical insert 510 and rigidly connected filter unit 100 in a secured state.

Turning now to FIGS. 13A and 13B there is illustrated a manipulating tool generally designated 550 configured for use in manipulating the main pipe 38 of the filtration system 10 disclosed in connection with the previous aspects, namely serving for slightly elevating the main pipe by several centimeters only, in order to detach its bottom portion 54 from the receiving portion 56 of the housing 30, thereby facilitating rotation of the main pipe about its longitudinal axis so as to maintain and service the system.

The device 550 comprises several legs 552 (three in the present example) fitted at their bottom end with a support pad 554 configured for bearing over a top surface 556 of the housing 30. Extending at the top of the support legs 552 there is a rigid plate 560 fitted with a centrally located threaded bore 564 receiving in turn a screw threaded crank 570 with a lever 572 and a manipulating handle 576. At a bottom of threaded portion 578 there is a hoisting hook 582 configured for coupling to hook 58 of the cover 42, with an interconnecting double hook 586 configured to facilitate axial displacement of the main pipe though prevent it from rotation until detached from the receiving portion 56 of the housing 30.

The arrangement is such that once the manipulating device 550 is positioned over the housing 30 and the top cover 42 of the main pipe 38 is coupled to the threaded portion 578 (via double hook 586), and upon rotating the crank as illustrated by arrowed line 588, the threaded portion axially displaces with respect to the plate 560 and slowly axially displaces the main pipe 38 respectively. Angular displacement of the main pipe 38 is facilitated manually, once hoisted by the manipulating device 550.

The main pipe 38 is manipulated (elevated and rotated) as required to service all filter units thereof, and then the main pipe 38 is lowered by rotating the crank 570 in a reverse direction, into to its fixed, operative position, in which it is arrested the receiving portion 56 of the housing 30.

1. A filtration system comprising a tank-like housing, accommodating a filtration assembly secured within the housing and extending between a respective raw fluid inlet port and a filtered fluid outlet port; said filtration assembly comprising one or more filter units secured over a main pipe disposed within the housing and configured between a fixed, operative position, and a manipulating position; said housing configured with at least one re-sealable opening on a side wall thereof, through which the filter units are serviced at the manipulating position.

2. A filtration system according to claim 1, wherein the main pipe is manipulable through an opening at a top portion of the housing, about a longitudinal axis thereof.

3. A filtration system according to claim 2, wherein the main pipe is rotatable about said longitudinal axis to facilitate access to all the filter units mounted on the main pipe through the at least one sealable opening on the side wall thereof

4. A filtration system according to claim 1, wherein the main pipe defines an internal confined space being in fluid communication with an external space within the housing only through said filter units.

5. A filtration system according to claim 4, wherein a bottom portion of the main pipe is sealingly yet detachably secured to a receiving portion of the housing.

6. A filtration system according to claim 1, wherein the main pipe is configured for detachably securing thereto a plurality of filter units.

7. A filtration system according to claim 6, wherein the filter units radially extend from the main pipe.

8. A filtration system according to claim 1, wherein the main pipe is configured for axial and rotary displacement about its longitudinal axis through an opening at a top portion of the housing and is fitted for sealing articulation thereto at the operative position.

9. A filtration system according to claim 1, wherein the main pipe is configured at a top portion thereof for detachably attaching to a manipulating system for hoisting and rotating same about its longitudinal axis.

10. A filtration system according to claim 1, wherein the at least one sealable opening on the side wall of the housing is configured for reopening and closing, however in a sealed fashion, to facilitate servicing the filter units.

11. A filtration system according to claim 1, wherein the filtration system is used as a ballast filtration system in a marine vessel.

12. A filtration system according to claim 1, wherein the one or more filter units are detachably attached to the main pipe in a sealed fashion by screw-type couplings.

13. An articulation mechanism for screw coupling a tubular element to a body, said tubular element comprising a cylindrical body configured at a coupling end thereof with an externally threaded segment and an outwardly extending shoulder above said threaded segment, a seal support ring received within the coupling end; said body configured with an opening having an internal threading corresponding with said external threading and a body shoulder, and a seat portion projecting inwards from the threading; whereby screw fastening the tubular element with the body entails screw coupling therebetween with sealing engagement of the sealing support ring against the seat portion and bearing of the shoulder against said body shoulder.

14. An articulation mechanism according to claim 13, wherein a sealing member is retained by the seal support ring,

15. An articulation mechanism according to claim 13, wherein a conical tightening ring is provided over at least a conical surface of the positioning segment of the body, said conical tightening ring bearing against at least a portion of the shoulder of the tubular element, whereby screw fastening the tubular element with the body entails urging of the conical tightening ring against the conical surface of the positioning segment, thereby causing the conical tightening ring to expend into a fastened sealed engagement therebetween.

16. An articulation mechanism according to claim 13, wherein the tubular element a is a filter unit and the body is a main pipe of a filtration system, and wherein the articulation mechanism is used for detachably attaching said filter unit to the main pipe.
